(19) United States
(12) Patent Application Publication
(10) Pub. No.: US 2006/0013351 A1
(43) Pub. Date: Jan. 19, 2006

(54) Integrated pedometer device for tracking an exercise regimen

(76) Inventor: Cynthia G. Crider, Celebration, FL (US)

Correspondence Address: FROST BROWN TODD, LLC, 2200 PNC CENTER, 201 E. FIFTH STREET, CINCINNATI, OH, 45202, US

(21) Appl. No.: 11/180,436

(22) Filed: Jul. 13, 2005

Related U.S. Application Data
(60) Provisional application No. 60/587,421, filed on Jul. 13, 2004.

(51) Int. Cl. G01C 21/00; G01C 22/00

(52) U.S. Cl. 377/24.2; 702/160

(57) ABSTRACT

A pedometer integrated into a commonly carried article enhances its utility, such as incorporating into a cell phone clip, eliminating the need for carrying a separate bulky item. Moreover, including a communication interface such that pedometer data may be date/time tagged and uploaded for storage and analysis supports an exercise regimen. Exercise performed over days, weeks and months may be efficiently recorded without the need to manually monitor and record such data.

### FIELD OF THE INVENTION

The present invention pertains to pedometers worn by an individual, and more particular, to a pedometer integrated into a portable consumer electronic device.

### BACKGROUND OF THE INVENTION

The problem with pedometers is that they are generally bulky and thus inconvenient for being worn. To the extent that pedometers have been integrated into worn items, such as a dog collar, such pedometers only benefit the user if the pedometer data is manually monitored and manually recorded, if at all, at the time of exercising.

### SUMMARY OF THE INVENTION

The present invention addresses these and other problems in the prior art by integrating a pedometer into a portable consumer electronic device, adding this additional functionality without increasing the amount of items requiring separate attachment.

In one version, a pedometer is integrated into a belt clip typically used to attach a cell phone, personal digital assistant (PDA) pager or other portable consumer electronic device. The belt clip would include a reset button, an on/off button, and a readout display (e.g., LED or LCD) display to display estimated distance traveled or number of strides. This pedometer and display may further be integrated with a time/date control and display.

The pedometer may be powered by battery or capacitor or by tapping into the adjacent portable consumer electronic device. Advantageously, a power supply that generates electrical power from motion may be incorporated to eliminate the need for replacing or recharging a power source. Sufficient capacitance and nonvolatile memory storage integrated into the system would suffice to bridge intermittent periods of being stationary.

In addition, the pedometer clip may advantageously include an interface ability to communicate by wireless or corded means the pedometer data to the portable consumer device, or periodically upload the pedometer data to a home personal computer, for recording and analysis. In particular, tracking of personal exercise over a period of days, weeks and months may enhance the sense of accomplishment as well as providing a basis for monitoring and analyzing the effectiveness of a personal exercise regimen. Thus, the pedometer exercise data may be linked with duration of exercise to estimate speed of travel, date and time of the exercise, etc.

In one particular application, the wireless technology commonly referred to as “BLUE TOOTH” may be implemented as a communication channel between an active pedometer and the portable consumer electronic device. A two-way communication channel may allow the active pedometer to update itself as to current date and time and perhaps user identity for tagging current exercise data as well as providing a channel for uploading the subsequent pedometer data.

It should be appreciated that other commonly carried items may benefit from incorporation of a pedometer, such as a shoe, belt, of the portable consumer electronic device itself. Given the reduced size of certain motion transducers, a number of applications would exist.

Further, to further leverage the pedometer data for long-term convenient tracking and analysis, data uploaded to a networked device (e.g., cell phone, Internet-capable device) may advantageously be uploaded to a personal homepage or centralized data repository accessible from a number of location and means, which typically would include security features for personal privacy. Thus, individuals who are travelling or otherwise do not have a regular means of uploading or transferring the current pedometer data would be able to do so through various devices.

What is claimed is:

1. A device, comprising:
a clock;
pedometer circuitry operably configured to track motions indicative of walking as pedometer data and to date tag the pedometer data;
transmission circuitry operably configured to transfer the date tagged pedometer data.

2. The device of claim 1, further comprising an attachment structure encompassing the clock, pedometer circuitry and transmission circuitry.

3. The device of claim 1, further comprising a networked device including receiving circuitry operably configured to received the date tagged pedometer data and including a pedometer database operably configured to store the date tagged pedometer data.
